(19) United States
(12) Patent Application Publication
(10) Pub. No.: US 2006/0288721 A1
(43) Pub. Date: Dec. 28, 2006

(54) Air conditioning system for vehicles

(75) Inventors: Masato Tsuboi, Isesaki-shi (JP); Kenichi Suzuki, Takasaki-shi (JP); Yuuichi Matsumoto, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Iseak-shi (JP)

(21) Appl. No.: 11/472,527

(22) Filed: Jun. 22, 2006

(30) Foreign Application Priority Data
Jun. 22, 2005 (JP) 2005-181795

(51) Int. Cl. B60H 1/32; F25B 41/00; F25B 39/02

(52) U.S. Cl. 62/239; 62/515; 62/513

(57) ABSTRACT

An air conditioning system for a vehicle includes an outdoor heat exchanger, an indoor heat exchanger, and an inside heat exchanger. The inside heat exchanger exchanges heat between a refrigerant at a high-pressure and a refrigerant at a low-pressure during a refrigeration cycle. Both the outdoor heat exchanger and the inside heat exchanger include a plurality of tubes, and each of the plurality of tubes has a plurality of holes formed therethrough, which extend parallel to each other in the tubes. A cross-sectional shape of the plurality of tubes in the inside heat exchanger is the same as a cross-sectional shape of the plurality of tubes in the outdoor heat exchanger.

### BACKGROUND OF THE INVENTION

1. Field of the Invention

The present invention relates generally to air conditioning systems for vehicles. More specifically, the present invention is directed towards vehicle air conditioning systems having an inside heat exchanger which may use a natural-system refrigerant, such as carbon dioxide, for a vapor compression refrigeration cycle.

2. Description of Related Art

Systems using carbon dioxide gas as a refrigerant generally comprise a compressor, a gas cooler, an inside heat exchanger, an expansion valve, an evaporator, and an accumulator. The gas cooler is an outdoor heat exchanger, which does not exchange heat directly with the vehicle interior. The evaporator is an indoor heat exchanger, which exchanges heat with the vehicle interior. The accumulator is a gas-liquid separator, such as the gas-liquid separator described in Japanese Patent Publication No. JP-B-7-18602. The inside heat exchanger exchanges heat between a high-pressure refrigerant and a low-pressure refrigerant in the refrigeration cycle.

A known inside heat exchanger is formed as a double pipe structure. In order to ensure a sufficient amount of heat exchange, a pipe length of at least 1 m is used. Nevertheless, this substantial pipe length creates a problem with mounting the heat exchanger onto a vehicle.

In order to address the mounting problem, a structure for integrating an inside heat exchanger and an outdoor heat exchanger is described in Japanese Patent Publication No. JP-A-2004-12097. Nevertheless, this known structure merely adds an inside heat exchanger to a known outdoor heat exchanger to create an integrated unit. Consequently, the integrated heat exchanger is relatively large, complicated, and costly to manufacture.

Japanese Patent Publication No. JP-A-2003-121086 describes a parallel, multi-hole flat tube, in which a plurality of holes extend in parallel to each other. Nevertheless, the holes for high-pressure refrigerant and the holes for low-pressure refrigerant are different sizes from each other, which creates a need to separately manufacture tubes for the inside heat exchanger and increases costs.

### SUMMARY OF THE INVENTION

Therefore, a need has arisen for vehicle air conditioning systems that overcome these and other shortcomings of the related art. A technical advantage of the present invention is that an inside heat exchanger may be readily mounted onto a vehicle. Another technical advantage of the present invention is that an inside heat exchanger may be manufactured at a relatively low cost.

An air conditioning system for a vehicle comprises an outdoor heat exchanger, an indoor heat exchanger, and an inside heat exchanger. The inside heat exchanger exchanges heat between a refrigerant at a high-pressure and a refrigerant at a low-pressure during a refrigeration cycle. The outdoor heat exchanger and the inside heat exchanger each comprise a plurality of tubes, and each of the plurality of tubes have a plurality of holes formed therethrough, which extend parallel to each other in the tube. A cross-sectional shape of the plurality of tubes in the inside heat exchanger is the same as a cross-sectional shape of the plurality of tubes in the outdoor heat exchanger.

Other objects, features, and advantages of the present invention will be apparent to persons of ordinary skill in the art from the following detailed description of preferred embodiments of the present invention and the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a schematic diagram of an air conditioning system for vehicles according to an embodiment of the present invention.

FIG. 2A is an elevational view of the integrated heat exchanger of FIG. 1.

FIG. 2B is a side view of the integrated heat exchanger of FIG. 1.

FIG. 2C is a bottom view of the integrated heat exchanger of FIG. 1.

FIG. 3A is an enlarged, partial, cross-sectional view of the integrated heat exchanger of FIG. 2A, as viewed along line III—III.

FIG. 3B is a cross-sectional view of a parallel, multi-hole flat tube of FIG. 3A, as viewed along line B-B.

FIG. 4 is a schematic diagram of a known air conditioning system for vehicles.

### DETAILED DESCRIPTION OF PREFERRED EMBODIMENTS

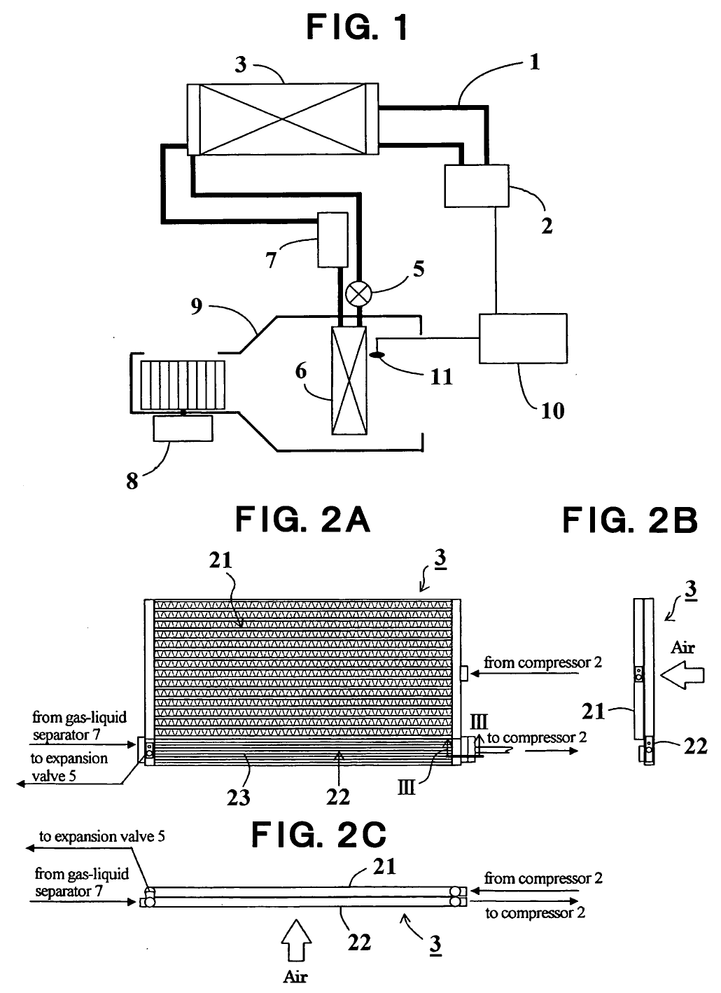

Embodiments of the present invention and their features and technical advantages may be understood by referring to FIGS. 1-3B, like numerals being used for like corresponding parts in the various drawings.

FIG. 1 depicts an air conditioning system for vehicles according to an embodiment of the present invention, in which an outdoor heat exchanger and an inside heat exchanger are integrated with each other. In FIG. 1, a vapor compression type refrigeration system 1 may comprise a compressor 2, an integrated heat exchanger 3, formed by integrating an outdoor heat exchanger and an inside heat exchanger, an expansion valve 5, an indoor heat exchanger 6, e.g., an evaporator, and a gas-liquid separator 7, e.g., an accumulator. Air for air conditioning may be sent into a duct 9 by a blower 8. The air may be cooled via heat exchange with refrigerant evaporated in indoor heat exchanger 6, and the temperature-controlled air may be sent into the vehicle interior. Controller 10 may send a control signal to compressor 2 for driving the compressor 2. The controller may use a detection signal from indoor heat exchanger temperature sensor 11 provided at the exit side of indoor heat exchanger 6 for controlling the feedback loop.

For the purpose of comparison, FIG. 4 depicts a known vapor compression type refrigeration cycle 100, in which an inside heat exchanger 12 is provided separately from an outdoor heat exchanger 4.

In the air conditioning system of FIG. 1, carbon dioxide gas may be used as the refrigerant. The refrigerant may be circulated during a refrigeration cycle in order from compressor 2, to an outdoor heat exchanger portion of integrated heat exchanger 3, to expansion valve 5, to indoor heat exchanger 6, to gas-liquid separator 7, and to an inside heat exchanger portion of integrated heat exchanger 3. The refrigerant then may return to compressor 2. The integrated heat exchanger 3 may be formed by integrating an inside heat exchanger with an outdoor heat exchanger, in which the outdoor heat exchanger functions as a gas cooler.

Referring to FIGS. 2A-2C, integrated heat exchanger 3 is depicted according to an embodiment of the present invention. Integrated heat exchanger 3 may comprise an outdoor heat exchanger portion 21, which functions as a gas cooler, and an inside heat exchanger portion 22. Refrigerant may enter from compressor 2 into the outdoor heat exchanger portion 21, and may flow to expansion valve 5. Refrigerant may enter heat exchanger portion 22 from gas-liquid separator 7, and may flow to compressor 2. Integrated heat exchanger 3 may perform heat exchange between low-pressure refrigerant passing through inside heat exchanger portion 22 and high-pressure refrigerant passing through outdoor heat exchanger portion 21. Moreover, at least a portion of inside heat exchanger portion 22 may be mounted at a position other than an outside air flowing route for cooling outdoor heat exchanger portion 21.

Gas cooler portion 21 and inside heat exchanger portion 22 may comprise parallel, multi-hole flat tubes 23 having an identical cross-sectional shape. For purposes of mass production, using the same cross-sectional shape for tubes 23 makes it unnecessary to prepare separate molds for manufacturing parallel multi-hole flat tubes for inside heat exchanger portion 22 as opposed to outdoor heat exchanger portion 21. The same raw materials may also be used during manufacture of both portions. As a result, integrated heat exchanger 3 may be manufactured relatively easily and at a low cost.

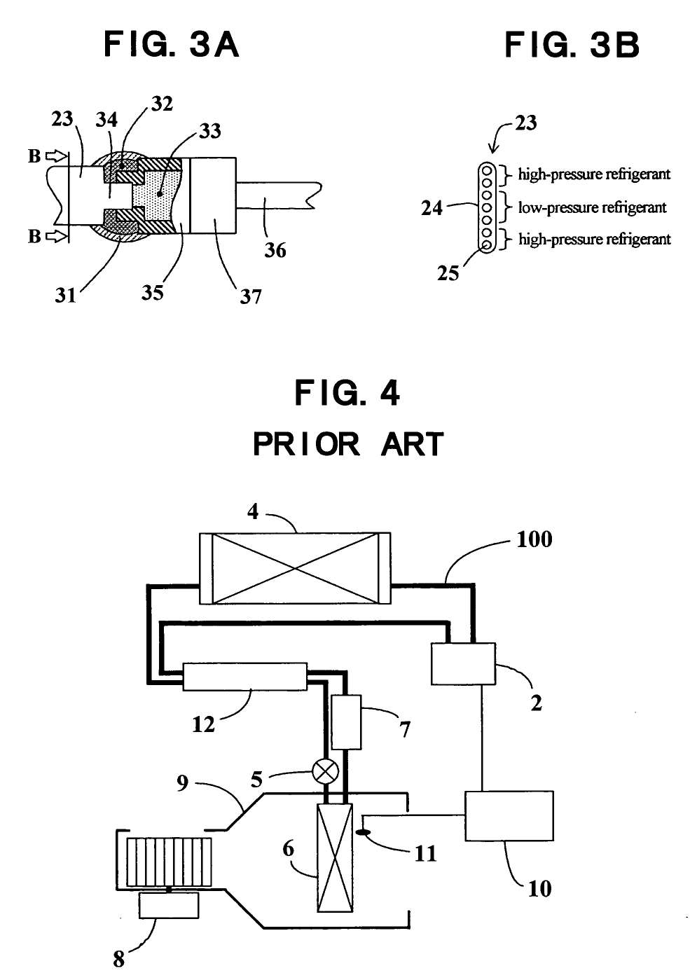

Parallel multi-hole flat tubes 23 may have a cross-sectional shape as depicted in FIG. 3B. For example, parallel multi-hole flat tubes 23 may be formed by providing a plurality of holes 25 in flat tube 24, such that the holes 25 extend in parallel to each other. In FIG. 3B, six holes 25 having a same size are arranged in a single row. In this embodiment, some of the high-pressure refrigerant flowing in outdoor heat exchanger portion 21 flows in holes 25 located at outer positions of the parallel multi-hole flat tube 23. Some the low-pressure refrigerant flowing through the inside heat exchanger portion flows in holes 25 formed at central positions of the row of holes in parallel multi-hole flat tube 23. The flows of the high-pressure refrigerant and the low-pressure refrigerant may be set at a counter flow (in opposite directions), and heat exchange may be performed between both flows (between the high-pressure refrigerant and the low-pressure refrigerant).

The high-pressure refrigerant and low-pressure refrigerant in integrated heat exchanger 3 may be separated at the end of parallel multi-hole flat tubes 23, for example, as shown in FIG. 3A. In this example, the interior of a header pipe 31, which forms a portion of inside heat exchanger portion 22, is divided into a region of high-pressure refrigerant 32 and a region of low-pressure refrigerant 33. The end of parallel multi-hole flat tube 23 comprises a protruding portion 34, as shown in FIG. 3A, and a pad 35. This configuration enables low-pressure refrigerant to flow in holes 25 (FIG. 3B), located at the position corresponding to the protruding portion 34, and the high-pressure refrigerant to flow in the other holes 25 (FIG. 3B), located at both sides of the hole row. A flange 37, located at an end of a pipe 36, may be connected to the pad 35. Moreover, a plurality of parallel multi-hole flat tubes 23 constructed in this manner may be stacked together and in contact with each other.

The structure described above permits holes 25 flowing low-pressure refrigerant and holes 25 flowing high-pressure refrigerant to be present in a single, parallel, multi-hole flat tube 2. Nevertheless, alternative structures may be employed. For example, a structure may be employed in which some parallel multi-hole flat tubes flow only low-pressure refrigerant and other parallel multi-hole flat tubes flow only high-pressure refrigerant. Although the tubes are formed separately, they may be stacked and may contact each other. Furthermore, a structure may be employed in which parallel multi-hole flat tubes flowing only high-pressure refrigerant are provided on both sides of one or more parallel multi-hole flat tubes flowing both low-pressure refrigerant and high-pressure refrigerant, such as the tube shown in FIG. 3B. In such a structure, the flow path of low-pressure refrigerant is surrounded by the flow path of high-pressure refrigerant, which provides a desirable formation for heat exchange.

In the present invention, it is possible to adjust the rate of heat exchange of the inside heat exchanger, i.e., the amount of inside heat exchange, by adjusting the number of parallel, multi-hole flat tubes flowing low-pressure refrigerant and the number of parallel multi-hole flat tubes flowing high-pressure refrigerant, or by adjusting the number of holes in the parallel, multi-hole flat tubes flowing low-pressure refrigerant and high-pressure refrigerant. The number of tubes and holes may be selected to achieve a desired ability for inside heat exchange.

Thus, as shown in the embodiment of FIGS. 2A-2C and FIGS. 3A and 3B, the inside heat exchanger and the outdoor heat exchanger may be efficiently integrated, while providing a desired amount of inside heat exchange. The resulting integrated heat exchanger may be light-weight, and may be readily mounted onto a vehicle. The air conditioning system for vehicles according to the present invention may be particularly suitable to a vapor compression type refrigerating cycle using a natural-system refrigerant, such as carbon dioxide.

While the invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. An air conditioning system for a vehicle, comprising:
an outdoor heat exchanger;
an indoor heat exchanger; and
an inside heat exchanger which exchanges heat between a refrigerant at a high-pressure and the refrigerant at a low-pressure during a refrigeration cycle, wherein each of said outdoor heat exchanger and said inside heat exchanger comprises a plurality of tubes, and each of said plurality of tubes has a plurality of holes formed therethrough, which extend parallel to each other in the tube, wherein a cross-sectional shape of said plurality of tubes in said inside heat exchanger is the same as a cross-sectional shape of said plurality of tubes in said outdoor heat exchanger.

2. The air conditioning system of claim 1, wherein said inside heat exchanger and said outdoor heat exchanger are integrated with each other to form an integrated heat exchanger, wherein said outdoor heat exchanger is an outdoor heat exchanger portion of the integrated heat exchanger, and said inside heat exchanger is an inside heat exchanger portion of said integrated heat exchanger.

3. The air conditioning system of claim 2, wherein said refrigerant comprises carbon dioxide.

4. The air conditioning system of claim 2 further comprising:
a compressor coupled to said outdoor heat exchanger portion and to said inside heat exchanger portion;
an expansion valve coupled to said outdoor heat exchanger portion and to said indoor heat exchanger; and
a gas-liquid separator coupled to said indoor heat exchanger and to said inside heat exchanger portion, wherein said refrigerant circulates through the system during said refrigeration cycle from said compressor, to said outdoor heat exchanger portion, to said expansion valve, to said indoor heat exchanger, to said gas-liquid separator, to said inside heat exchanger portion, and returns to said compressor.

5. The air conditioning system of claim 4, wherein said refrigerant is at a high pressure when said refrigerant travels between said outdoor heat exchanger and said expansion valve, and said refrigerant is at a low pressure when said refrigerant travels between said gas-liquid separator and said compressor, wherein said integrated heat exchanger exchanges heat between said low-pressure and said high-pressure refrigerant.

6. The air conditioning system of claim 2, wherein said inside heat exchanger portion is formed by flowing said low-pressure refrigerant through a first plurality of said plurality of tubes of the integrated heat exchanger, and said high-pressure refrigerant flows through a second plurality of said plurality of tubes of said integrated heat exchanger.

7. The air conditioning system of claim 2, wherein said inside heat exchanger portion is formed by flowing said low-pressure refrigerant through a first plurality of said plurality of holes in a first plurality of said plurality of tubes, and high-pressure refrigerant flows through a second plurality of said plurality of holes in a second plurality of said plurality of tubes.

8. The air conditioning system according to claim 6, wherein said plurality of tubes are stacked and contact each other.

9. The air conditioning system of claim 2, wherein said plurality of holes form at least one parallel row in each tube, and said low-pressure refrigerant flows through a first plurality of said plurality of holes, which are formed at a central position of each of said plurality of tubes, wherein said high-pressure refrigerant flows through the plurality of holes which are not included in said first plurality of said plurality of holes.

10. The air conditioning system of claim 2, wherein said low-pressure refrigerant and said high-pressure refrigerant flow in opposite directions through said plurality of tubes.

11. The air conditioning system of claim 2, wherein tubes of said plurality of tubes that flow only said high-pressure refrigerant are provided on both sides of one or more of said plurality of tubes that flow both said low-pressure refrigerant and said high-pressure refrigerant.

12. The air conditioning system of claim 2, wherein an interior of a header pipe forming said integrated heat exchanger is divided into a region of high-pressure refrigerant and a region of low-pressure refrigerant.

13. The air conditioning system of claim 12, wherein an end portion of at least one tube of said plurality of tubes forming said inside heat exchanger comprises a protruding portion, and an attachment to said end portion of said at least one tube is formed, such that low-pressure refrigerant flows in a first plurality of said plurality of holes, which are formed at a position corresponding to said protruding portion, wherein high-pressure refrigerant flows in a second plurality of said plurality of holes.

14. The air conditioning system of claim 1, wherein at least a portion of said inside heat exchanger is mounted at a position other than an outside air flowing route for cooling said outdoor heat exchanger.
